(19) United States
(12) Patent Application Publication
(10) Pub. No.: US 2022/0292796 A1
(43) Pub. Date: Sep. 15, 2022

(54) METHOD AND SYSTEM FOR ASSOCIATING DEVICE COORDINATE SYSTEMS IN A MULTI-PERSON AR SYSTEM

(71) Applicant: GUANGDONG OPPO MOBILE TELECOMMUNICATONS CORP., LTD., Dongguan (CN)

(72) Inventor: Yi Xu, Palo Alto, CA (US)

(21) Appl. No.: 17/832,387

(22) Filed: Jun. 3, 2022

Related U.S. Application Data
(63) Continuation of application No. PCT/CN2020/133384, filed on Dec. 2, 2020.
(60) Provisional application No. 62/944,131, filed on Dec. 5, 2019.

(51) Int. Cl. G06T 19/20; G06T 19/00; G06F 3/01; G06T 7/73

(52) U.S. Cl. CPC G06T 19/20; G06T 19/006; G06F 3/011; G06T 7/74; G06T 2219/024; G06T 2219/2016; G06T 2207/30204

(57) ABSTRACT

Methods and systems are disclosed mapping the coordinate systems of devices for an augmented-reality application. A first pose defined relative to a first coordinate system associated with a first mobile device may be received by a second mobile device. An image of a display of the first mobile device presenting a fiducial marker may be received by the second mobile device. Data indicating three-dimensional coordinates of the first mobile device can be identified and used to define a second pose of the second mobile device associated with the coordinate system of the first device. A coordinate-system transform that maps coordinates between the first coordinate system of the first mobile device and the second coordinate system of the second mobile device can be generated using the second pose. A first virtual object can be presented on a display of the second mobile device based on the coordinate-system transform.

### CROSS-REFERENCE TO RELATED APPLICATION(S)

This application is a continuation of International Application No. PCT/CN2020/133384, filed Dec. 2, 2020, which claims priority to U.S. Provisional Patent Application No. 62/944,131, filed Dec. 5, 2019, the entire disclosures of which are incorporated herein by reference.

### FIELD

The present disclosure relates generally to augmented reality, and more specifically, and without limitation, to mapping coordinate systems of multiple devices.

### BACKGROUND

Augmented reality presentations can project virtual objects within a real-world environment displayed on a display of a device. A camera of an augmented-reality device can capture real-world environment. A virtual object may be created and presented by a display of the device such that the virtual object appears as if naturally positioned within the environment. For instance, a camera may capture live video of a real-world environment that includes empty picnic table. The augmented-reality device may generate a virtual object that is presented as if positioned on the picnic table. The virtual object is presented on a display device in substantially the same manner as the object would appear if physically located on the picnic table.

In multi-device augmented-reality systems, each device may present a virtual representation of the real world-environment. In particular, each device presents the virtual representation of the environment from that device's perspective. Thus, it can be important in such systems that the virtual environment is consistently presented across the devices.

### SUMMARY

Aspects of the present disclosure include methods for mapping coordinate systems of devices in a multi-person augmented-reality application. The method comprises: receiving, by a second mobile device, data indicative of a first pose of a first mobile device, wherein the first pose is defined relative to a first coordinate system associated with the first mobile device; determining, by the second mobile device, a second pose of the second mobile device, wherein the second pose is defined relative to a second coordinate system associated with the second mobile device; receiving, by the second mobile device, an image of a display of the first mobile device, the image showing a fiducial marker; identifying, by the second mobile device, based on the first pose and the image, three-dimensional coordinates associated with the fiducial marker, the three-dimensional coordinates defined relative to the first coordinate system; determining, based on the three-dimensional coordinates, a third pose of the second mobile device, wherein the third pose is defined relative to the first coordinate system associated with the first mobile device; and generating, by the second mobile device based on the second pose and the third pose, a coordinate-system transform that maps coordinates between the first coordinate system and the second coordinate system.

Another aspect of the present disclosure includes a mobile device comprising one or more processors and a non-transitory computer-readable media that includes instructions that when executed by the one or more processors, cause the one or more processors to perform methods described above.

Another aspects of the present disclosure include a non-transitory computer-readable media that includes instructions that when executed by one or more processors, cause the one or more processors to perform the methods described above.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 is an illustration of an augmented-reality system in which the coordinate systems of multiple device can be mapped according to at least one aspect of the disclosure.

FIG. 2 illustrates examples of fiducial markers that may be presented on a first device for multi-device coordinate system mapping according to at least one aspect of the disclosure.

FIG. 3A illustrates a process for generating a pose of a device relative to a coordinate system of another device according to at least one aspect of the disclosure.

FIG. 3B illustrates a process for generating a coordinate-system transform according to at least one aspect of the disclosure.

FIG. 4 is a flowchart of a process for mapping the coordinate systems of two mobile devices according to at least one aspect of the disclosure.

FIG. 5 illustrates examples of components of a computing system that executes an augmented-reality application according to at least one aspect of the disclosure

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Augmented-reality applications execute on devices to present virtual objects within contemporaneously captured video of a real-world environment within which the devices are located. A device may present the captured video on a display of the device with a virtual object presented therein such that the virtual object appears properly in the real-world environment. For instance, the virtual object may be presented on the display in substantially the same position and orientation as how a corresponding real-world object would appear if the real-world object was physically positioned in the real-world environment. In order to maintain the coherence of the virtual object as the device moves, the device may track its position and orientation within the real-world environment to ensure the virtual object continues to appear properly despite changes in the device's perspective. The position and orientation define a pose of the device. The device may define a coordinate system to map the real-world environment to the virtual environment and track its pose with regarding to this coordinate system.

In multi-device augmented-reality applications, the same virtual object can be presented on each display of multiple devices located in a real-world environment. Typically, each device executes a tracking process, such a SLAM process, to track its pose (e.g., position and orientation) within the real-world environment according to its own coordinate system. Since the coordinate systems of the devices differ, transformation between the coordinate systems may be needed in order to display instances of the same virtual object on the devices in a coordinated and coherent manner. The transformation can be generated based on one or more of the devices displaying known fiducial markers or natural images and remaining devices capturing images of these fiducial markers or natural images.

In an example, during an AR calibration procedure, a first device may track its pose (T₁₁) relative to a first coordinate system of the first device. Similarly, a second device may track its pose (T₂₂) relative to a second coordinate system of the second device. As used herein, a pose (Tᵢⱼ) refers to the pose of device “i” in a coordinate system “j.” The first device may present a fiducial marker or a marker image on a display of the first device and transmit its pose (T₁₁) (or a sequence of poses (T₁₁)) together with a timestamp (or a sequence of timestamps with each timestamp in the sequence corresponding to a pose of the sequence of poses) to the second device, Each pose may be tracked in the first coordinate system. The marker image may be any image that may have detectable features usable by a device to define a pose of the device relative to the detectable features.

The second device may capture a single or a sequence of images of the fiducial marker or the marker image displayed by the first device. A best image of the sequence of images and the pose (T₂₂) of the second device that matches the timestamp of the pose (T₁₁) may be selected. Based on the image, the second device detects feature points from the fiducial marker or the marker image. Once detected, the second device derives three-dimensional (3D) coordinates of the fiducial points from the pose of the first device (T₁₁), known information about the fiducial marker or marker image, and known information about the geometry of the first device to establish a correspondence between the 3D coordinates and the 2D feature points. By using a perspective-n-point technique based on the correspondence, the second device can derive its pose (T₂₁) in the first coordinate system. The two poses (T₂₁) and (T₂₂) of the second device relative in the first coordinate system and the second coordinate system, respectively, can be used to generate a coordinate-system transformation. The coordinate-system transformation can transform a position and orientation from the first coordinate system to the second coordinate system and vice versa.

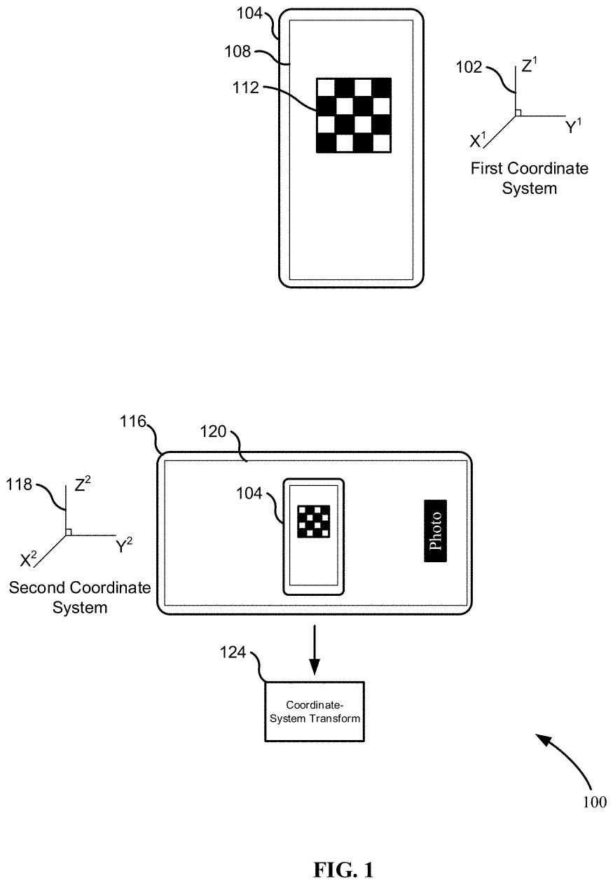

FIG. 1 is an illustration of an augmented-reality system 100 in which a transformation between coordinate systems of multiple device can be determined according to at least one aspect of the disclosure. Augmented-reality system 100 includes multiple devices, such as a first device 104 and a second device 116. The devices 104 and 116 are located in a real-world environment. Each of the devices 104 and 116 executes an AR application to display a virtual representation of the real-world environment, where the virtual environment includes virtual objects.

In an example, the first device 104 may present a virtual object on display 108 of the first device 104 as if the virtual object was a physical object positioned within the real-world environment. The presentation of the virtual object within the virtual environment is based on a first coordinate system 102 of the first device 104. A second device 116 may also present another instance of the virtual object on its display 120. Here also, this presentation depends on a second coordinate system 118 of the second device 116. For the instances of the virtual object to be presented in a coordinated and coherent manner of displays 108 and 120, a transformation 124 between the first coordinate system and the second coordinate system is needed.

During a calibration of the augmented-reality applications executing on the first device 104 the second device 116, the second coordinate system 118 of the second device 116 can be mapped to the first coordinate system 102 of the first device 104 without using a fixed reference point in the environment. Instead, and as further described herein below, the first device 104 presents a reference to the second device 116 and the second device 116 generates and processes an image of this reference to define the transformation between the two coordinate systems. Other operations are performed during the calibration. For instance, the first device 104 may execute a process to track its pose relative to the first coordinate system 102. Similarly, the second device 116 may also track its pose relative to the second coordinate system 118. After the calibration, each device may begin presenting virtual objects in a coordinated and coherent manner based on the transformation between the coordinate systems and on tracked poses.

For instance, during the calibration, it can be determined that a current position of the first device 104 is at the origin of its own coordinate system 102. The first device 104 may track its own movement using internal sensors (e.g., accelerometers, global positioning system (GPS) sensors, compass, combinations thereof, or the like), image processing (e.g., using machine-learning, deep learning, or the like), or a combination thereof and update its position within coordinate system 102. The first device 104 may not know the environment within which it is positioned, but it may track its position relative to where the first device 104 was initially calibrated (e.g., its origin). For instance, if the internal sensor indicate that the first device 104 has moved a meter after the calibration, the position of the first device 104 may be determined as being a meter (in a particular direction) from the origin. Thus, the coordinate system 102 of the first device 104 may be used to indicate a relative location of the first device 104 (e.g., relative to the location of the first device 104 at the calibration time), but not necessarily the absolute location of the first device 104 since the environment may be unknown.

In some instances, the first device 104 may execute a simultaneous localizations and mapping (SLAM) process that may define the coordinate system 102 and track the pose of the devices within its environment. SLAM processes may be used to track the first device 104 within a real-world environment even when the real-world environment is unknown (at least initially) to the SLAM process. SLAM processes may take as input variables such as, but are not limited to, control data ct, sensor data st, and time intervals t and generate an output that may include an approximate location of the device xt for at a given time interval and a map of the environment mt.

A SLAM process may initiate with a calibration step in which coordinate system 102 may be initialized representing the real-world environment with the first device 104 positioned at the origin. As the first device 104 captures sensor data that indicates movement in a particular direction (and optionally image data from a camera of the first device 104 that may be used to indicate objects within the environment), the SLAM process may update xt and mt. SLAM may be an iterative process that updates xt and mt in set time intervals or when new sensor data or image data can be detected. For instance, if no sensor change occurs between time interval t and t+1, then the SLAM process may delay updating the position and map to preserve processing resources. Upon detecting a change in sensor data indicating a high probability that the device has moved from its previous position xt, the SLAM process may compute the new position of device xt and update the map mt. The same processes may be performed by the second device 116 to define the coordinate system of the second device 116 and the position and orientation n of the second device 116 relative to a coordinate system 118.

Once the initial poses of the first device 104 and the second device 116 are detected, the first device 104 may present a fiducial marker 112 (or some other type of a reference) on display 108 of the first device 104. Fiducial marker 112 may be predetermined such that the size, shape, color, pattern, shading, etc. may be known to the devices of multi-device augmented-reality system 100. For instance, fiducial marker 112 may be a checkerboard pattern of black and white squares of known size. Upon displaying fiducial marker 112, the first device 104 may transmit its pose defined in the first coordinate system 102, instructions for capturing an image of fiducial marker 112, and, optionally, information about the geometry of the first device 104 (e.g., size of the screen), and a fiducial marker identifier that indicates the particular fiducial marker presented by the first device 104 to the second device 116. In some instances, the first device 104 may transmit a sequence of poses with each pose of the sequence of poses including a first timestamp corresponding to an instant in time in which the pose was determined.

The second device 116 may be directed to capture an image of the fiducial marker being displayed by the first device 104. If more than one pose was received from the first device, the second device may select the pose from the sequence of poses with a first timestamp that is closest to a second timestamp corresponding to an instant in which the image was captured. In some instances, the second device 116 may capture a sequence of images to ensure that at least one image of the sequence of images captured particular features of the fiducial marker needed to define a coordinate-system transform. Each image may include a second timestamp indicating an instant in which the image was captured. The second device may select the best image from the sequence of images. If more than one pose was received from the first device, the second device may select the pose from the sequence of poses with the first timestamp that is closest to the second timestamp of the best image.

In some instances, the second device 116 may use two (or more) poses received from the first device 104. For instance, the second device 116 identify two or more poses that were determined (based on their respective timestamps) closest in time to the instant that the best image was captured. The second device may then interpolate between the two poses received from the first device 104 using the corresponding timestamps of the poses to generate a new pose of the first device 104 that corresponds to the pose of the first device at the instant in which the best image was captured by the second device 116.

In some instances, the second device 116 may pre-store device geometry information of the first device 104 and/or possible fiducial markers that the first device 104 may present. For example, the second device 116 may load the device geometry information and the known characteristics of the fiducial marker from local memory. If more than one type of device may be used in the AR application, the second device 116 may receive an identifier, such as a device model identifier, to determine the proper device geometry information. The device geometry information may be received from local memory or from a server. If the first device 104 does not transmit a fiducial marker identifier, the second device 116 may identify the fiducial marker using a classifier in conjunction with one or more image processing techniques, such as edge detection.

Since the size, color, pattern, etc. of the fiducial marker are known, the image of fiducial marker 112 can be processed to define a set of two-dimensional (2D) feature points. Each 2D feature point may correspond to a point within fiducial marker 112 such as the center of a square, a vertex between squares, a corner of the fiducial marker, or any other point of the fiducial marker that can be readily identified based on a characteristic of the fiducial marker. The set of 2D feature points may be processed along with the pose of the first device 104 within the environment relative to the coordinate system 102 of the first device 104 and the known geometry information of the first device to identify 3D coordinates of each feature point. A correspondence between the set of 2D feature points and each 3D coordinates can be used to compute a pose of the second device 116 relative to the coordinate system 102 of the first device 104. The pose can be used to generate a coordinate-system transform that can map feature points of the coordinate system 102 of the first device 104 and the second coordinate system 118 of the second device 116.

Mapping the second coordinate system to the first coordinate system may be performed during the calibration. In some instance, the mapping process may be performed again after the calibration such as when the SLAM process resets (as this will initiate a new coordinate system for that device), after a calibration value indicates that the mapping is no long accurate, or upon a predetermined time interval lapsing.

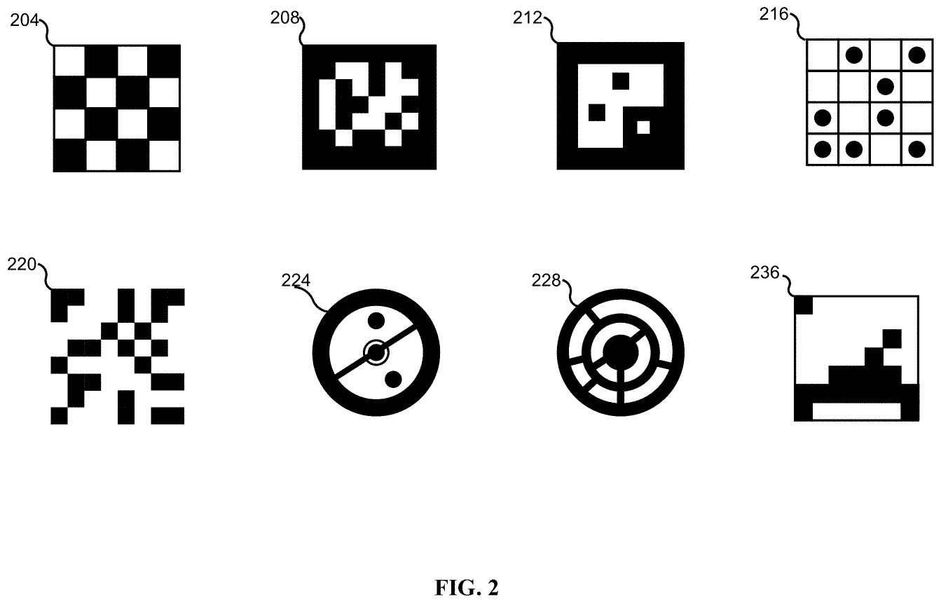

FIG. 2 illustrates examples of fiducial markers that may be presented on a first device for multi-device coordinate system mapping according to at least one aspect of the disclosure. Markers 204-236 may be fiducial markers that may be used to map coordinates of a first coordinate system to corresponding coordinates of a second coordinate system. Fiducial markers 204-236 may include a predefined size, shape, and pattern that can be known to a device that captures an image of the fiducial marker. Since the characteristics of the fiducial marker are known, image processing (for example) may be used to detect the fiducial marker (once captured by a camera of the device). Characteristics of the fiducial marker captured in an image can be used to, for example, define a location of the device relative to the fiducial marker, determine the scale of objects within the real-world environment, determine an orientation of the device, map the coordinate system of the device to another device, and the like.

For instance, characteristics of each fiducial marker may be selected to enable detection of the fiducial marker and its feature points regardless of the particular rotation or transformation of the maker within the captured image. For instance, a fiducial marker may include one or more shapes within the fiducial marker that appear differently when rotated or transformed so as to indicate a degree of rotation and/or transformation upon detection. The degree of rotation/transformation may be used to determine the orientation of the device that captured the image. For instance, if the fiducial marker in the image is rotated 45 degrees, then it can be determined that the device is also rotated by 45 degrees.

In some instances, one or more rotations, affine transformations, Euclidean transformations, reflections, transpositions, combinations thereof may be performed on the image of the fiducial marker and output a processed fiducial marker that appears in a predetermined orientation. For instance, the device capturing the fiducial marker may store characteristics of the fiducial marker (e.g., size, pattern, colors, etc.). Yet, the fiducial marker may not appear as expected (e.g., rotated, blurry, stretched, etc.). The image may be processed to isolate the fiducial marker and rotate and/or transform the fiducial marker such that fiducial marker appears in an expected orientation. In other instances, the image of the fiducial marker may not be processed to change the orientation of the fiducial marker within the image.

Devices detect the orientation of the fiducial marker by detecting one or more feature points of the fiducial marker. Feature points may be detected using the detected characteristics of the fiducial marker and the known characteristics of the fiducial marker. For instance, feature points may be based on particular characteristics of the maker. For instance, fiducial marker 204 can be a checkerboard pattern. Feature points may be detected at the vertices between each set of four squares, at the center of each white square or black square, at the corners, at the corners of each white square, at the corners of each black square, combinations thereof, or the like. Each fiducial marker may include one or more feature points that can be detected within an image. In some instance, each fiducial marker may include three or more feature points. While any number of feature points may be detected, the more feature points that can be detected the greater the accuracy in mapping the coordinate systems.

Devices may use image processing to detect the fiducial marker from other portions of the image as well as to detect feature points from the fiducial marker. One such image processing technique includes edge detection. Edge detection may include a filtering technique in which one or more filters can be applied to the image. Filters may modify the image by, blurring, sharpening, transforming (such as, but not limited to one or more affine transformations, Euclidian transformations, or the like), and/or the like. Filters may reduce image noise by, for example, removing image artifacts and/or other portions of the image that does not correspond to the fiducial marker.

In some instances, an image may have some portions that may be processed more than other portions of the image. For instance, a portion of the image to appear blurry and another portion of the image may be clear. Different filters may be applied to different portions of the image, and in addition, a different set of filters may be applied to different portions of the image. Different filters may be applied to different portions of the image. For example, a first portion of the image may be filtered to sharpen the first portion and a second portion of the image may be filtered with an affine transformation filter and noise reduction. Any number of different filters may be applied to the image and/or each patch.

Once the filters are applied, edge detection may identify variations in pixel intensity gradients across adjacent pixels. Large variations in the intensity between adjacent pixels can be indicative of the presence of an edge. For example, a first pixel with a high intensity value next to pixels with a low intensity values can provide an indication that the first pixel is part of an edge. In some instances, pixels that are not part of edges may be suppressed (e.g., set to a predetermined red/green/blue value, such as black, where red=0, blue=0, and green=0, or any predetermined red/green/blue value). An edge detection operator such a Roberts cross operator, a Prewitt operator, a Sobel operator, and/or the like may be used as part of the identification of the pixel intensity gradients.

A non-maximum suppression process may be used to suppress pixels that do not correspond strongly to an edge. The non-maximum suppression process assigns an edge strength value to each pixel identified using the pixel intensity gradient as being part of an edge. For each pixel identified as being part of an edge, the pixel's edge strength value can be compared to the edge strength value of the pixel's s eight surrounding pixels. If the pixel has a higher edge strength value than the edge strength value of the surrounding pixels (e.g., local maxima), then the surrounding pixels are suppressed. Non-maximum suppression may be repeated for each pixel in the entire image.

A double threshold process may then be executed to remove noise and/or spurious edge pixels that carried through application of previous image processing techniques applied herein. Two thresholds of pixel intensities may be defined, one high and one low. The thresholds may be used to assign an intensity property to each pixel as being strong or weak. Pixels that include an intensity value higher than the high threshold can be assigned a strong intensity property, where pixels that include an intensity value that is between the high threshold and the low threshold can be assigned a weak intensity property. Pixels that include an intensity value below the low threshold may be suppressed (e.g., in the same manner as described above).

A hysteresis process may then be executed to remove pixels with a weak intensity property (that is weak due to noise, color variation, etc.). For example, a local statistical analysis (e.g., a connected-component analysis, etc.) may be performed for each pixel with a weak intensity property. Pixels with a weak intensity property that are not surrounded by a pixel that includes a strong intensity property may be suppressed. The remaining pixels (e.g., the un-suppressed pixels) after the hysteresis process include only those pixels that are part of edges. Although the above five processing processes were described in a particular order, each process may be executed any number of times (e.g., repeated), and/or executed in any order without departing from the spirit or the scope of the present disclosure. In some instances, only a subset of the five processes need be performed on the image. For example, image processing may perform identification of the pixel intensity gradients process without first performing a filtering process. In some instances, images may be received partially processed (e.g., one or more of the processes above having already been performed). In those instances, one or more additional processes may be performed to complete the image processing.

In some instances, signal processing may be performed on the image (e.g., similar to a radio frequency signal). The image may be transformed into a frequency domain (e.g., using a Fourier transform or the like) to represent the frequency in which a particular pixel characteristic exists in the image (e.g., pixel intensities, RGB values, and/or the like). In the frequency domain, one or more filters (such as, but not limited to, Butterworth filters, band pass, and/or the like) may be applied to the image (e.g., during preprocessing, edge detection, or after) to suppress or alter particular frequencies. Suppressing particular frequencies can reduce noise, eliminate image artifacts, suppress non-edge pixels, eliminate pixels of particular colors or color gradients, normalize color gradients, and/or the like. A high-pass filter may reveal edges in an image (e.g., sharp contrasts of color and/or intensity between adjacent pixels) while a low-pass filer may blend edges (e.g., blur). Image padding may be performed prior to signal processing to improve the signal processing techniques. In some instances, different portions and/or patches of the image may be processed differently with some being processed with a high-pass filter and others with a low-pass filter. In some instances, the thresholds (e.g., the cutoff frequency for the high or low-pass filters) may be modified for different portions of the image (e.g., based on image processing one or more previous images, machine-learning, and/or the like).

Signal processing may also determine other properties of the image such as coherence (e.g., used in edge detection, segmentation, pattern analysis, etc.), which identifies the relation between pixels. The relation between pixels can be used to further refine edge detection and/or to identify the structural properties of what is depicted within the image. For example, coherence can be used to identify portions of the image that are related (e.g., portions of a same object) from parts of the image that are not.

Markers 204-236 are examples of fiducial markers that can be used to map the coordinate systems of two or more devices. For instance, fiducial marker 204 may be a checkerboard pattern with alternating squares of two or more colors. In some instances, the colors may have a high degree of contrast such as white and black. In other instance, one or more colors other than black and white may be used such as red, green, and/or blue (or alternatively cyan, magenta, and/or yellow). In still yet other instances, contrasting pattern fill may be used in which one set of squares may not include a pattern, and another set of squares may use cross-hatching. Marker 204 may or may not include a border that surrounds the fiducial marker as edge detection may be used to define the borders of the fiducial marker.

Markers can have irregular shapes and may not conform to set patterns. For instance, fiducial markers 208, 212, 220, and 236 include a set of black squares dispersed a predefined area. The square shape of the fiducial marker may be used, in part, to determine the particular contours of the fiducial marker. In addition, the dispersal pattern of the set of squares (e.g., the distance between two or more particular squares, etc.), may be used to indicate the position of the device that captured the image. For instance, the distance between two non-adjacent squares may be known to the device. The device may calculate the difference between the known distance and the distance detected in a captured image. The larger the difference between the known value and the distance calculated from the image, the further away the camera may be from the fiducial marker.

Similarly, the size of particular sets of squares may be calculated and compared to known sizes. Variations in sizes of the squares can be used to determine the orientation of the device relative to the fiducial marker. For instance, one side of squares is larger than the squares of the other sides, the camera of the device may have captured the image of the fiducial marker from an angle offset and not perpendicular from the fiducial marker.

In some instances, a fiducial marker may have a non-square shape such as fiducial markers 224 and 228. Markers 224 and 228 may have a circular shape with internal circular shapes. In some instances, one or more additional shapes may be included within those fiducial markers such as the lines that bisect the circles. These additional shapes may indicate an orientation of the fiducial marker so as to indicate the orientation of the device.

Although particular shapes are shown in FIG. 2 having a particular pattern, shape, color, orientation, and/or the like fiducial markers may have any particular shape that may be geometric such the squares and circles shown, or amorphous.

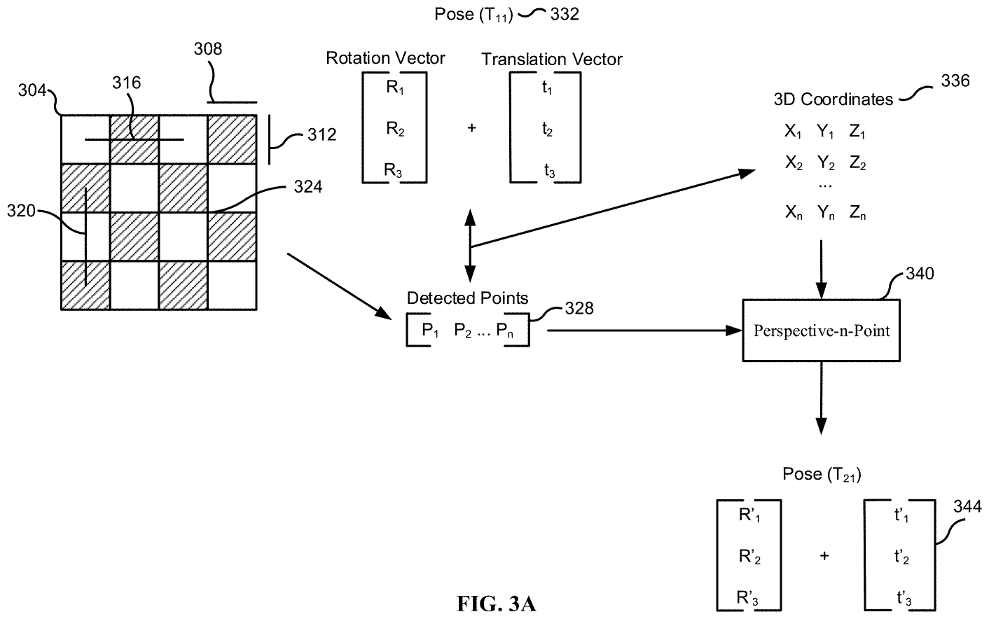

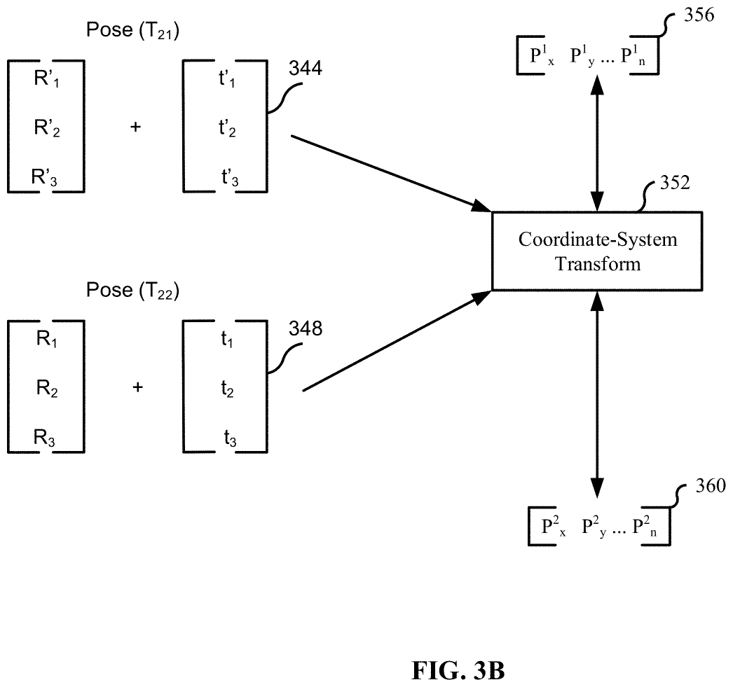

FIG. 3A illustrates an example of generating a pose of a device relative to a coordinate system of another device according to at least one aspect of the disclosure. A second device may capture an image of a first device that is presenting fiducial marker 304. One or more feature points of fiducial marker 304 may be detected. Feature points can be any visually distinctive point of a fiducial marker. In some instances, detecting feature points within a fiducial marker may include detecting the size of individual components of the fiducial marker such as size 308 and 312. In addition, the distances between non-adjacent shapes such as 316 and 320 may be detected to determine the orientation of the camera that captured the image. In other instances, the size of individual shapes or the distances between non-abject shapes may be determined using the feature points detected within the fiducial marker. The feature points may be detected based on particular characteristics of fiducial marker 304. For instance, fiducial marker 304 may include feature points at each vertex 324 formed by two adjacent shapes that share a common color. Marker 304 may include nine feature points. Other fiducial markers may include more or less feature points. The feature points may be aggregated into a set of feature points 328.

A pose (T₁₁) 332 of the first device at the instant in which the image of maker was captured may be received by the second device. A pose may represent a position and an orientation of the first device relative to the coordinate system of the first device. In some instances, pose 332 may be represented by a rotation vector R[R₁, R₂, R₃] and a translation vector t[t₁, t₁, t₁]. In other instances, pose 332 may be represented as a transformation matrix. Pose (T₁₁) may be determined using a SLAM process executing on the first device, image processing of images captured by the first device, device geometry information such as the dimensions of the device, camera information (e.g., scaled focal lengths, skew parameter, principle point, scale factors, or the like), internal sensors (e.g., accelerometers, gyroscopes, compasses, or the like), combinations thereof, or the like.

The pose (T₁₁) of the first device and the set of feature points may be used to identify data indicative of three-dimensional coordinates 336 of each feature point of the set of feature points relative to the coordinate system of the first device. For instance, each feature point may represent a 2D coordinate associated with the fiducial marker displayed on the first device. The pose of the first device represents the first device's position and orientation. The combination of device geometry information and the position and orientation of the first device can be used to generate a 3D coordinate (in the first coordinate system) for each feature point.

A correspondence between the feature points and the three-dimensional coordinates of the feature points may be established. The second device may execute a perspective-n-point process using the correspondence between the three-dimensional coordinates and the set of feature points to generate the current pose of the second device relative to the coordinate system of the first device. For instance, the set of feature points may be used to determine the position and orientation of the second device relative to the set of feature points. Since the correspondence links the three-dimensional coordinates (that are based on the coordinate system of the first device) and the set of feature points, the second device may identify its position and orientation, or pose 344 (T₂₁), relative to the coordinate system of the first device.

FIG. 3B illustrates a process for generating a coordinate-system transform according to at least one aspect of the disclosure. The pose (T₂₁) 344 of the second device relative to the coordinate system of the first device may be used along with the pose (T₂₂) of the second device relative to the coordinate system of the second device to generate a coordinate-system transform 352. Coordinate-system transform may be used to map points (e.g., coordinates) of the second coordinate system to corresponding coordinates in the first coordinate system and vice versa.

For instance, a set of points 360 may be points within the second coordinate system that correspond to a virtual object. The virtual object may be presented within a display of a first device by converting the set of points 360 to the corresponding set of points 356 of the first coordinate system. Coordinate-system transform may convert points from the second coordinate system into corresponding points in the first coordinate system and/or convert points from the first coordinate system into corresponding points in the second coordinate system. Thus, the coordinate-system transform can be used to present virtual objects defined according to one coordinate system in substantially the same position and orientation in the other coordinate system.

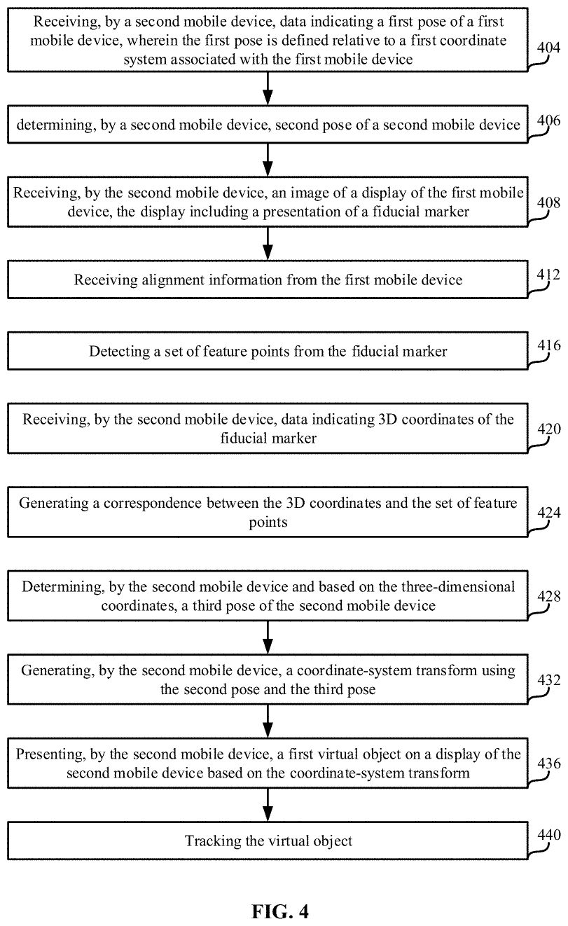

FIG. 4 is a flowchart of a process for mapping the coordinate systems of two mobile devices according to at least one aspect of the disclosure. At block 404, a first pose (T₁₁) of a first mobile device may be received. The first mobile device may execute a position tracking process, such as a SLAM process, that tracks the pose (T₁₁) of the first mobile device associated with the coordinate system of the first mobile device. The first pose, (T₁₁), received at block 404 may be a particular pose at a particular instant in time. The first pose may be associated with a first timestamp corresponding to an instant in which the first pose was determined. In some instances, a sequence of poses may be received with each pose of the sequence of poses being associated with a corresponding first timestamp.

At block 406, a second pose (T₂₂) may be determined by the second device. The second pose (T₂₂) may be defined relative to the coordinate system associated with the second mobile device. The second pose may be determined using a position tracking process, such as a SLAM process.

At block 408, an image of a fiducial marker presented on a display of the first mobile device may be received by the second mobile device. The image of the fiducial marker may be associated with a second timestamp indicating an instant in which the image was captured. In some instances, a sequence of images of the fiducial marker may be captured with each image being associated with a corresponding second timestamp. For example, the second mobile device may receive instructions (e.g., from a server or the first mobile device) for using a camera of the second mobile device to take a picture of the display of the first mobile device while the first mobile device is presenting the fiducial marker. The instructions may be presented on a display of the second mobile device. In another example, the image(s) may be received by the second mobile device via a network connection or the like. The fiducial marker may be any marker of predetermined size and geometry.

Though a fiducial marker is described, any type of markers can be used. Generally, an image is generated by a mobile device, while the mobile is in operation (e.g., during an AR session). The image shows elements within the real world environment. These elements can be used as markers in the example flow of FIG. 4 and the embodiments of the present disclosure. One example of the elements is the fiducial markers. Other examples of elements include a landmark such as unique architecture or a portion thereof within the real-world environment, an identifiable feature of the real world environment, a graphic within the real world environment, a graphic overlaid on the image, and the like.

At block 412, alignment information may be received by the second mobile device. The alignment information may be transmitted to the second mobile device from the first mobile device or form a server. The alignment information can include the pose (or the sequence of poses) of the first mobile device, an identification of the fiducial marker displayed by the first mobile device, device geometry information of the first device, a device model identifier of the first device, and/or the like. In some instance, some of the alignment information may be received from the first mobile device and some of the alignment information may be received from a server. For instance, the device model identifier of the first mobile device may be used to look up the device geometry information from the memory of the second mobile device or form the server. It may not be necessary to obtain the device geometry information if the device model identifier of the first device matches the device model identifier of the second mobile device. In other instances, all of the alignment information may be received from the first mobile device. The second mobile device may receive the alignment information at substantially the same time as the image of the fiducial marker is obtained at block 410, shortly beforehand, or shortly afterwards.

A block 416, a set of feature points can be detected from the image of the fiducial marker. If a sequence of images were captured, the best image from the sequence of images may be selected and the set of feature points may be detected using the best image. The best image may be the image that captured a view of the entire fiducial marker, which has the highest number of visible feature points, the clearest image, the image with the fewest image artifacts or defects, or the like. Since the fiducial marker has a known size and geometry, the feature points can be used to determine a pose of the second mobile device relative to the fiducial marker. In some instances, the set of feature points includes three feature points. In other instances, the set of feature points includes four or more feature points.

At block 420, data indicative of three-dimensional coordinates may be defined. The three-dimensional coordinates may be defined using the first pose, mobile device geometry information, and the set of feature points. If the second device received a sequence of poses, the second mobile device may select a particular pose from the sequence of poses as the first pose. The particular pose may be the pose that has a first timestamp that is closest to the second timestamp of the captured image (or selected best image if more than one images was captured). For instance, if the sequence of poses p1, p2, and p3 are associated with first timestamps t1, t2, and t3 (respectively) and the captured image is associated with second timestamp t2.1, then pose p2 will be selected as the first pose as p2 is associated with first timestamp t2 which is closest to the second timestamp t2.1 of the captured image. In some instances, if a timestamp of a pose does not approximately equal a corresponding timestamp of an image, the second device may interpolate between two poses of the first device using the corresponding timestamps of each pose to compute the pose of the first device at the exact instant when the best image was captured by the second device. For example, poses p2 and p3 can be interpolated to compute the pose of the first device at timestamp t2.1 of the captured image. The known size and geometry of the fiducial marker may be exploited by using the mobile device geometry to estimate a physical position of each feature point displayed on the display of the first mobile device. The pose of the first mobile device can be used to determine a three-dimensional coordinate of each feature point in the first coordinate system.

At block 424, a correspondence between the three-dimensional coordinates and the set of feature points can be generated. The correspondence may represent a mapping that links the three-dimensional coordinates (associated with the first coordinate system) and the feature points of the image of the fiducial marker.

At block 428, a third pose (T₂₁) of the second mobile device relative to the first coordinate system may be defined using the correspondence between the three-dimensional coordinates and the set of feature points. For instance, a perspective-n-point process may use the correspondence as input (along with camera calibration data such as scaled focal lengths, skew parameter, principal point, scale factor, and/or the like) to generate an estimated third pose of the second mobile device. The third pose of the second mobile device may be associated with the coordinate system of the first mobile device.

At block 432, a coordinate-system transform may be generated using the second pose (T₂₂) of the second mobile device relative to the a coordinate system associated with the second mobile device and the third pose (T₂₁) of the second mobile device relative to the coordinate system the first mobile device. The coordinate-system transform may map points in the first coordinate system of the first mobile device to corresponding points in the second coordinate system of the second mobile device. In some instances, the positions computed by the SLAM process of the first mobile device may be transformed into the positions in the second coordinate system of the second mobile device. In other instances, the positions computed by the SLAM process of the second mobile device may be transformed into the positions in the first coordinate system of the first mobile device.

At block 436, an instance of a virtual object may be presented on a display of the second mobile device based on the coordinate-system transform in a natural and coherent manner with respect to the display of a second instance of the virtual object presented on a display of the first mobile device. For instance, the second mobile device may receive data associated with the virtual object from the first mobile device such as, for example, the 3D coordinates of the virtual object in the first coordinate system. The second mobile device may use the coordinate-system transform to convert the 3D coordinates of the virtual object associated with the first coordinate system into to 3D coordinates in the second coordinate system. The second mobile device may present the instance of the virtual object using the 3D coordinates of the virtual object in the second coordinate system.

For instance, in an augmented-reality application, the second mobile device may capture images or video of an environment. The second mobile device may define an instance of virtual object that is to be presented on a display of the second mobile device as if physically located within the environment. The SLAM process may track the second mobile device as it moves within the environment such that the virtual object continues to appears as if physically (and naturally) located within the environment (regardless of the second mobile device's change in position or orientation).

The first mobile device then may cause a second virtual object (e.g., an instance of the virtual object) to be presented within the display of the first mobile device at approximately the same position and orientation within the virtual environment as the virtual object. For instance, the first device may capture images/video of the environment and present the second virtual object within the captured images/video such that the second virtual object appears as if physically (and naturally) located within the environment (regardless of the second mobile device's change in position or orientation).

At block 440, the first coordinate system may be synchronized with the second coordinate system by continuously tracking the first mobile device and the second mobile device (e.g., using respective SLAM process executing the respective mobile devices) according to the mapped coordinate system.

The process of FIG. 4 may be executed entirely by the first mobile device, partially by the first mobile device, entirely by the second mobile device, partially by the second mobile device, entirely by a server, or partially by the server. The server may direct the mapping of the coordinate systems of the first mobile device and the second mobile device and execute all or part of the augmented-reality application. For example, the first mobile device may define the first pose (using a SLAM process executed by the first mobile device) and the second mobile device may define the second pose (using a SLAM process executed by the second mobile device). The second mobile device may be directed to obtain an image of the fiducial marker presented on the display of the first mobile device. The second mobile device may detect the set of feature points. In some instances, the first pose may be transmitted to the second mobile device and the second mobile device may identify the three-dimensional coordinates. In other instances, the set of feature points maybe transmitted to the first mobile device and the first mobile device may identify the three-dimensional coordinates. In still yet other instances, the set of feature points set of feature points may be transmitted to a server. The server may identify the three-dimensional coordinates.

Continuing the example, the second pose may be defined by the second mobile device or by a server that transmits the defined second pose back to the second mobile device. The second mobile device may use the second pose to generate the coordinate-system transform to map positions of the second coordinate system to positions of the first coordinate system. In some instances, the first mobile device may use the second pose to generate the coordinate-system transform to map positions of the first coordinate system to positions of the second coordinate system. The coordinate-system transform may be used with the SLAM process executing on the second mobile device to track virtual objects within an environment that are defined according the coordinate system of the first device.

The blocks of FIG. 4, though presented in a particular order, may be executed in any particular order. In some instances, each block of FIG. 4 may be executed one or more times before moving on the next block. Although FIG. 4 describes mapping the coordinate systems of two devices, the process of FIG. 4 may be extended to mapping the coordinate systems of any number of devices by for example, having each additional device execute the processes of 404-432. For instance, each additional device may use the first device as a reference object or any other device with a coordinate system that has been previously mapped with the coordinate system of the first device.

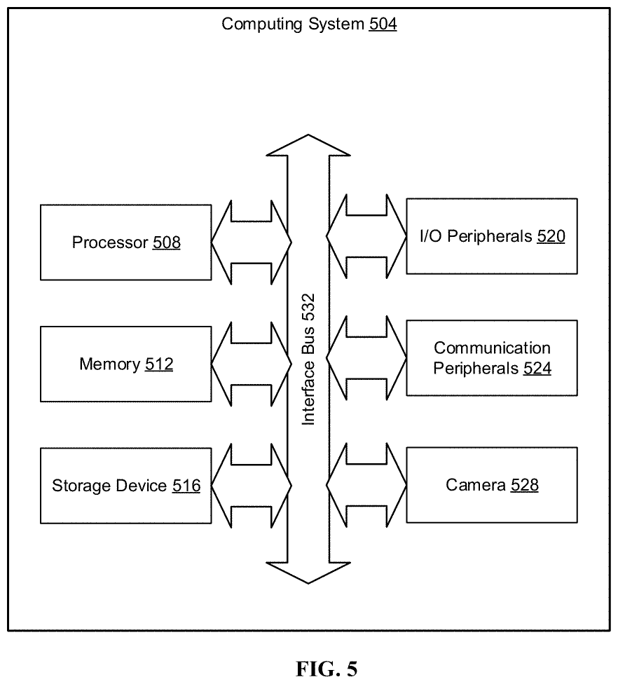

FIG. 5 illustrates examples of components of a computing system that executes an augmented-reality application according to at least one aspect of the disclosure. Computing system 504 can be an example of a mobile device described in connection FIG. 4. Although these components are illustrated as being part of computing system 504, computing system 504 can also be distributed such that some components may be positioned within a different hardware platform than other components.

Computing system 504 includes at least a processor 508, a memory 512, a storage device 516, input/output peripherals (I/O) 520, communication peripherals 524, one or more cameras 528, and an interface bus 532. Interface bus 532 can be configured to communicate, transmit, and transfer data, controls, and commands among the various components of computing system 504. Memory 512 and storage device 516 can include computer-readable storage media, such as RAM, ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer readable storage media can be configured to store instructions or program codes embodying aspects of the disclosure. Memory 512 and storage device 516 may also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the computing system 504.

Further, memory 512 can includes an operating system, programs, and applications. Processor 508 may be configured to execute the stored instructions and includes, for example, a logical processing unit, a microprocessor, a digital signal processor, and other processors. Memory 512 and/or processor 508 can be virtualized and can be hosted within another computing system of, for example, a cloud network or a data center. I/O peripherals 520 can include user interfaces, such as a keyboard, screen (e.g., a touch screen), microphone, speaker, other input/output devices, and computing components, such as graphical processing units, serial ports, parallel ports, universal serial buses, and other input/output peripherals. I/O peripherals 520 are connected to processor 508 through any of the ports coupled to interface bus 532. Communication peripherals 524 may be configured to facilitate communication between computing system 504 and other computing devices over a communications network and include, for example, a network interface controller, modem, wireless and wired interface cards, antenna, and other communication peripherals.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

While the principles of the disclosure have been described above in connection with specific apparatuses and methods, it is to be clearly understood that this description is made only by way of example and not as limitation on the scope of the disclosure.

What is claimed is:

1. A method of associating device coordinate systems in a multi-person augmented-reality system, the method comprising:
receiving, by a second mobile device, data indicative of a first pose of a first mobile device, wherein the first pose is defined relative to a first coordinate system associated with the first mobile device;
determining, by the second mobile device, a second pose of the second mobile device, wherein the second pose is defined relative to a second coordinate system associated with the second mobile device;
receiving, by the second mobile device, an image of a display of the first mobile device, the image showing a marker;
identifying, by the second mobile device, based on the first pose and the image, three-dimensional coordinates associated with the marker, the three-dimensional coordinates defined relative to the first coordinate system;
determining, based on the three-dimensional coordinates, a third pose of the second mobile device, wherein the third pose is defined relative to the first coordinate system associated with the first mobile device; and
generating, by the second mobile device based on the second pose and the third pose, a coordinate-system transform that maps coordinates between the first coordinate system and the second coordinate system.

2. The method of claim 1, wherein determining the third pose of the second mobile device comprises:
identifying a set of feature points from the marker; and
generating a correspondence between the set of feature points and the three-dimensional coordinates associated with the marker.

3. The method of claim 2, wherein the set of feature points comprises three or more feature points.

4. The method of claim 1, wherein the first pose is represented by a rotation vector and a translation vector, and wherein the three-dimensional coordinates associated with the marker are defined, at least in part, using the first pose and information about a geometry of the first mobile device.

5. The method of claim 1, wherein a first virtual object presented by the second mobile device corresponds to a second virtual object presented by the first mobile device, and wherein the first virtual object appears in a substantially same position and substantially same orientation within an environment as the second virtual object.

6. The method of claim 1, wherein the coordinate-system transform comprises a transformation matrix defined from a rotation and a translation between the second pose and the third pose.

7. The method of claim 1, wherein the first pose comprises a first timestamp corresponding to an instant in time in which the first pose was determined.

8. The method of claim 1, further comprising:
presenting, by the second mobile device, a first virtual object on a display of the second mobile device based on the coordinate-system transform.

9. A mobile device for associating device coordinate systems in a multi-person augmented-reality system, the mobile device comprising:
one or more processors; and
a non-transitory computer-readable medium storing instructions that, when executed by the one or more processors, cause the one or more processors to perform operations including:
receiving data indicative of a first pose of another mobile device, wherein the first pose is defined relative to a first coordinate system associated with the other mobile device;
determining a second pose of the mobile device, wherein the second pose is defined relative to a second coordinate system associated with the mobile device;
receiving an image of a display of the other mobile device, the image showing a marker;
identifying, based on the first pose and the image, three-dimensional coordinates associated with the marker, the three-dimensional coordinates defined relative to the first coordinate system;
determining, based on the three-dimensional coordinates, a third pose of the mobile device, wherein the third pose is defined relative to the first coordinate system; and
generating a coordinate-system transform based on the second pose and the third pose, wherein the coordinate-system transform maps coordinates between the first coordinate system and the second coordinate system.

10. The mobile device of claim 9, wherein determining the third pose of the mobile device comprises:
identifying a set of feature points from the marker; and
generating a correspondence between the set of feature points and the three-dimensional coordinates associated with the marker.

11. The mobile device of claim 10, wherein the set of feature points comprises three or more feature points.

12. The mobile device of claim 9, wherein the first pose is represented by a rotation vector and a translation vector, and wherein the three-dimensional coordinates are defined, at least in part, using the first pose and information about a geometry of the other mobile device.

13. The mobile device of claim 9, wherein the operations further comprise:
presenting, on a display, a first virtual object, wherein the first virtual object corresponds to a second virtual object presented by the other mobile device, and wherein the first virtual object appears in a substantially same position and substantially same orientation within an environment as the second virtual object.

14. The mobile device of claim 9, wherein the coordinate-system transform comprises a transformation matrix defined from a rotation and a translation between the second pose and the third pose.

15. The mobile device of claim 9, wherein the first pose comprises a first timestamp corresponding to an instant in time in which the first pose was determined.

16. A non-transitory computer-readable medium storing instructions for associating device coordinate systems in a multi-person augmented-reality system, the instructions, when executed by one or more processors, cause the one or more processors to perform operations comprising:
receiving data indicative of a first pose of a first mobile device, wherein the first pose is defined relative to a first coordinate system associated with the first mobile device;
determining a second pose of a second mobile device, wherein the second pose is defined relative to a second coordinate system associated with the second mobile device;
receiving an image of a display of the first mobile device, the image showing a marker;
identifying, based on the first pose and the image, three-dimensional coordinates associated with the marker, the three-dimensional coordinates defined relative to the first coordinate system;
determining, based on the three-dimensional coordinates, a third pose of the second mobile device, wherein the third pose is defined relative to the first coordinate system; and
generating a coordinate-system transform based on the second pose and the third pose, wherein the coordinate-system transform maps coordinates between the first coordinate system and the second coordinate system.

17. The non-transitory computer-readable medium of claim 16, wherein determining the third pose of the second mobile device comprises:
identifying a set of feature points from the marker; and
generating a correspondence between the set of feature points and the three-dimensional coordinates associated with the marker.

18. The non-transitory computer-readable medium of claim 16, wherein the first pose is represented by a rotation vector and a translation vector, the rotation vector and the translation vector indicating a position of the first mobile device within the first coordinate system and an orientation of the first mobile device.

19. The non-transitory computer-readable medium of claim 16, wherein the three-dimensional coordinates associated with the marker are defined, at least in part, using the first pose and information about a geometry of the first mobile device.

20. The non-transitory computer-readable medium of claim 16, wherein the operations further comprise:
presenting, on a display of the second mobile device, a first virtual object, wherein the first virtual object corresponds to a second virtual object presented by the first mobile device, and wherein the first virtual object appears in a substantially same position and substantially same orientation within an environment as the second virtual object.
